(19) United States
(12) Patent Application Publication
(10) Pub. No.: US 2012/0234902 A1
(43) Pub. Date: Sep. 20, 2012

(54) MULTISTACK SOLDER WAFER FILLING

(75) Inventors: S. Jay Chey, Hartsdale, NY (US); David Danovitch, Canton de Granby (CA); Peter A. Gruber, Mohegan Lake, NY (US); Cornelia K. Tsang, Mohegan Lake, NY (US)

(73) Assignee: INTERNATIONAL BUSINESS MACHINES CORPORATION, Armonk, NY (US)

(21) Appl. No.: 13/487,378

(22) Filed: Jun. 4, 2012

Related U.S. Application Data
(62) Division of application No. 12/571,965, filed on Oct. 1, 2009.

(51) Int. Cl. B23K 31/02; B23K 3/06

(52) U.S. Cl. 228/260; 228/33

(57) ABSTRACT

A plurality of through-substrate holes is formed in each of at least one substrate. Each through-substrate hole extends from a top surface of the at least one substrate to the bottom surface of the at least one substrate. The at least one substrate is held by a stationary chuck or a rotating chuck. Vacuum suction is provided to a set of through-substrate holes among the plurality of through-substrate holes through a vacuum manifold attached to the bottom surface of the at least one substrate. An injection mold solder head located above the top surface of the at least one substrate injects a solder material into the set of through-substrate holes to form a plurality of through-substrate solders that extend from the top surface to the bottom surface of the at least one substrate. The vacuum suction prevents formation of air bubbles or incomplete filling in the plurality of through-substrate holes.

### CROSS REFERENCE TO RELATED APPLICATION

This application is a divisional of U.S. patent application Ser. No. 12/571,965, filed Oct. 1, 2009 the entire content and disclosure of which is incorporated herein by reference.

### BACKGROUND

The present invention generally relates to apparatuses and methods for forming seamless solder structures through at least one substrate.

As consumer products such as mobile phones become thinner, highly integrated semiconductor chips are needed to provide multiple functions within a single portable device. In such devices, power and ground interconnects as well as signal interconnects extend not only across a single substrate including a semiconductor chip, but also across multiple substrates that include multiple semiconductor chips that are vertically stacked. Such vertically stacked substrates are typically called “multistacks.” Providing conductive interconnect structures for such multistacks is a costly and time-consuming process.

Typically, line cavities and via holes in each dielectric layer are patterned and filled with a conductive material for each substrate to form conductive lines and conductive vias. Patterning and filling of the line cavities and via holes is typically effected by a combination of lithographic processes, anisotropic etching, and deposition of a conductive material. The deposition of a conductive material includes deposition of an adhesion/seed layer by means such as chemical vapor deposition (CVD) or physical vapor deposition (PVD), a subsequent via fill by a CVD, PVD, or a plating process, and a planarization process to remove excessive material from a top surface of the topmost dielectric layer. The conductive materials commonly used for conductive lines and conductive vias include polysilicon, tungsten, and copper.

Once each substrate is provided with conductive lines and conductive vias, inter-substrate electrical connection is provided typically in the form of metallic bumps, which can be a solder ball. Such bump interconnects usually require compatible under-bump metallurgies (ubm) to be formed on each substrate surface followed by deposition of the metallic bumps on at least one of the two mating substrate surfaces. The two substrates are then interconnected by aligning interconnect bumps and/or ubm pads of each mating substrates then forming metallurgical connections by means of solder reflow or thermocompression. As such, any use of solder for interconnection is limited to the space between two substrates but not extending into any of the two substrates.

### BRIEF SUMMARY

In an embodiment of the present invention, a plurality of through-substrate holes is formed in at least one substrate. Each through-substrate hole extends from a top surface of the at least one substrate to the bottom surface of the at least one substrate. The at least one substrate is held by a stationary chuck or a rotating chuck. Vacuum suction is provided to a set of through-substrate holes among the plurality of through-substrate holes through a vacuum manifold attached to the bottom surface of the at least one substrate. An injection mold solder head located above the top surface of the at least one substrate injects a solder material into the set of through-substrate holes to form a plurality of through-substrate solders that extend from the top surface to the bottom surface of the at least one substrate. The vacuum suction prevents formation of air bubbles or incomplete filling in the plurality of through-substrate holes.

According to an aspect of the present invention, an apparatus for forming at least one seamless conductive solder structure through at least one substrate is provided. The apparatus includes an upper assembly, a lower assembly, and a vacuum pump. The upper assembly and the lower assembly are configured to move relative to each other. The upper assembly, which is located above the lower assembly, is configured to provide a solder material through an opening on a bottom surface of the upper assembly. The lower assembly includes a chuck including a vacuum pumping line that is connected to the vacuum pump. The lower assembly is configured to laterally confine the at least one substrate. A filter structure, located within a recessed region of the chuck, is configured to vertically support a bottom surface of the at least one substrate. The filter structure is connected to the vacuum pumping line. The upper assembly injects the solder material through at least one through-substrate hole extending from a top surface of the at least one substrate to the bottom surface of the at least one substrate to form at least one through-substrate seamless conductive solder structure that extends from the top surface of the at least one substrate to the bottom surface of the at least one substrate.

According to another aspect of the present invention, an apparatus for forming at least one seamless conductive solder structure through at least one substrate is provided. The apparatus includes a set of an upper assembly and a lower assembly, a middle assembly, and a vacuum pump. The middle assembly and the set of the upper and lower assemblies are configured to move relative to each other, while the upper assembly maintains a same relative position with respect to the lower assembly. The upper assembly, which is located above the middle assembly, is configured to provide a solder material through an opening on a bottom surface of the upper assembly. The middle assembly includes a first chuck configured to laterally confine the at least one substrate. The first chuck maintains a same relative position with respect to the at least one substrate. The lower assembly includes a second chuck including a vacuum manifold that is connected to the vacuum pump. The upper assembly injects the solder material through at least one through-substrate hole extending from a top surface of the at least one substrate to a bottom surface of the at least one substrate to form at least one through-substrate seamless conductive solder structure that extends from the top surface of the at least one substrate to the bottom surface of the at least one substrate.

According to yet another aspect of the present invention, a method of forming at least one seamless conductive solder structure through at least one substrate is provided. The method includes providing an apparatus including an upper assembly, a lower assembly, and a vacuum pump. The upper assembly and the lower assembly of the apparatus are configured to move relative to each other. The lower assembly of the apparatus includes a chuck and a filter structure, and the chuck includes a vacuum pumping line that is connected to the vacuum pump. The filter structure is located within a recessed region of the chuck. At least one substrate, which includes at least one through-substrate hole extending from a top surface of the at least one substrate to the bottom surface of the at least one substrate, is placed on the filter structure. The chuck laterally confines the at least one substrate, and the filter structure vertically supports the bottom surface of the at least one substrate. A solder material is injected from the upper assembly into the at least one through-substrate hole. During the injection, the pump provides vacuum environment to an unfilled portion of a through-substrate hole into which the solder material is injected. At least one through-substrate seamless conductive solder structure that extends from the top surface of the at least one substrate to the bottom surface of the at least one substrate is provided.

According to still another aspect of the present invention, a method of forming at least one seamless conductive solder structure through at least one substrate is provided. The method includes providing an apparatus including a set of an upper assembly and a lower assembly, a middle assembly, and a vacuum pump. In this apparatus, the middle assembly and the set of the upper and lower assemblies are configured to move relative to each other while the upper assembly maintains a same relative position with respect to the lower assembly. The middle assembly includes a first chuck configured to laterally confine the at least one substrate and maintain a same relative position with respect to the at least one substrate. The lower assembly includes a second chuck including a vacuum pumping line that is connected to the vacuum pump. At least one substrate, which includes at least one through-substrate hole extending from a top surface of the at least one substrate to the bottom surface of the at least one substrate, is placed on the second chuck. The first chuck laterally confines the at least one substrate and the second chuck vertically supports the bottom surface of the at least one substrate. A solder material is injected from the upper assembly into the at least one through-substrate hole. During the injection, the pump provides a vacuum environment to an unfilled portion of a though-substrate hole into which the solder material is injected. At least one through-substrate seamless conductive solder structure that extends from the top surface of the at least one substrate to the bottom surface of the at least one substrate is provided.

### BRIEF DESCRIPTION OF SEVERAL VIEWS OF THE DRAWINGS

FIG. 1A is a schematic top-down view of a first exemplary apparatus according to a first embodiment of the present invention.

FIG. 1B is a schematic vertical cross-sectional view of the first exemplary apparatus in FIG. 1A along the plane B-B′.

FIG. 1C is a schematic vertical cross-sectional view of the first exemplary apparatus in FIG. 1A along the plane C-C′.

FIG. 2 is a schematic top-down view of a second exemplary apparatus according to a second embodiment of the present invention.

FIG. 3A is a schematic top-down view of a third exemplary apparatus according to a third embodiment of the present invention.

FIG. 3B is a schematic vertical cross-sectional view of the third exemplary apparatus in FIG. 3A along the plane B-B′.

FIG. 3C is a schematic vertical cross-sectional view of the third exemplary apparatus in FIG. 3B along the plane C-C′.

### DETAILED DESCRIPTION

As stated above, the present invention relates to apparatuses and methods for forming seamless solder structures through at least one substrate, which are now described in detail with accompanying figures. Throughout the drawings, the same reference numerals or letters are used to designate like or equivalent elements. The drawings are not necessarily drawn to scale.

As used herein, “at least one substrate” refers to a single substrate or a plurality of substrates that are vertically stacked together.

As used herein, a “through-substrate hole” refers to a cavity that extends from a topmost surface of at least one substrate to a bottommost surface of the at least one substrate. A through-substrate hole extends from a top surface of a single substrate to a bottom surface of the single substrate, or from a top surface of a topmost substrate in a plurality of substrates to a bottom surface of a bottommost substrate in the plurality of substrates.

As used herein, a “through-substrate solder structure” refers to a contiguous solder structure that extends from a topmost surface of at least one substrate to a bottommost surface of the at least one substrate. A through-substrate solder structure extends from a top surface of a single substrate to a bottom surface of the single substrate, or from a top surface of a topmost substrate in a plurality of substrates to a bottom surface of a bottommost substrate in the plurality of substrates.

As used herein, a “partially-filled through substrate hole” refers to a solder structure that partially fills a through-substrate hole but does not completely fill the through-substrate hole.

As used herein, a “seamless conductive solder structure” refers to a structure of a conductive solder material that is in one contiguous piece without a seam or an interface therein.

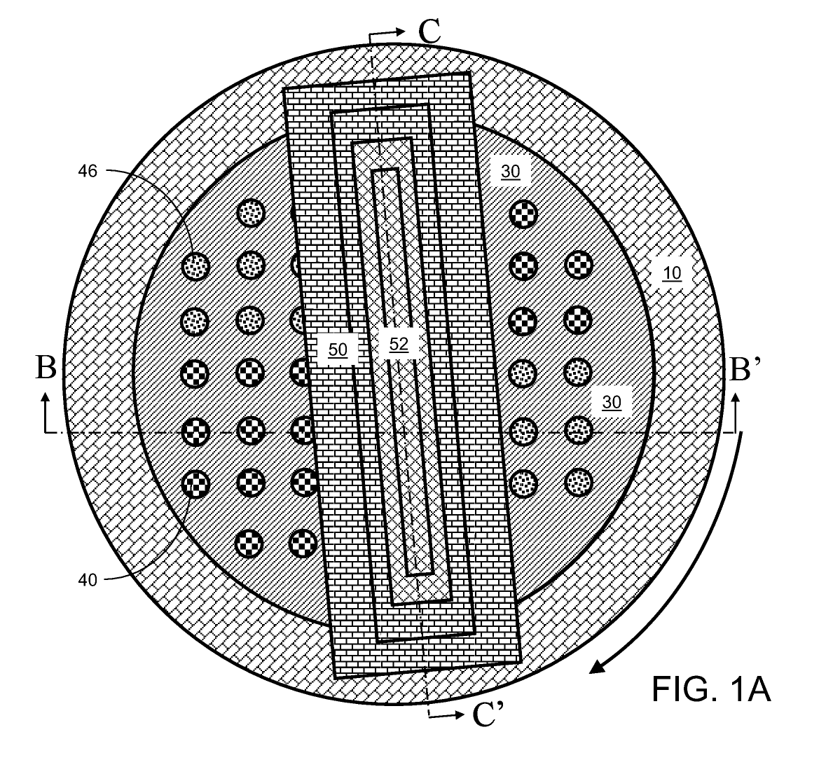

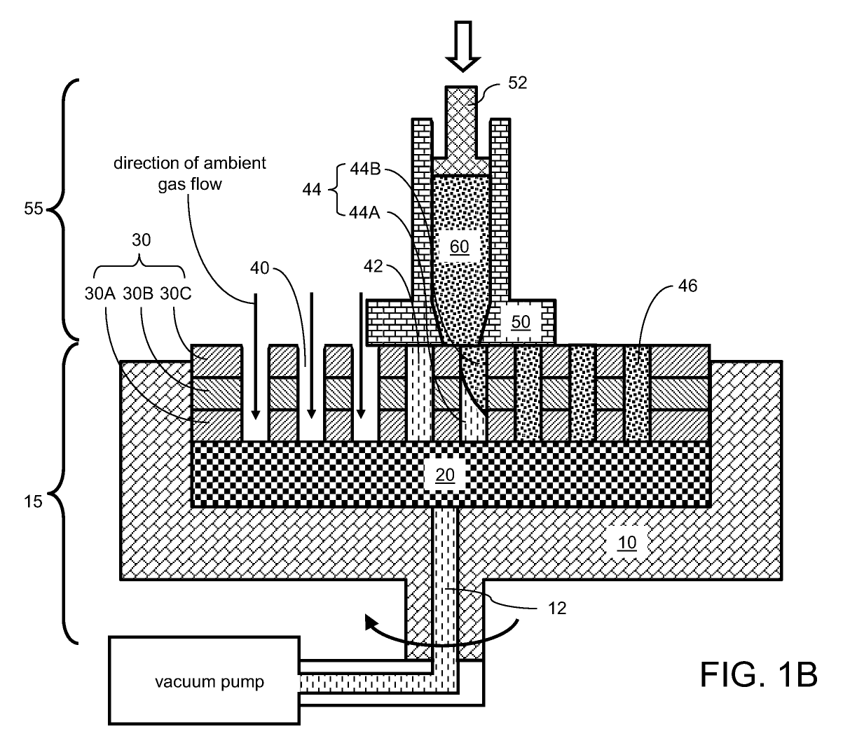

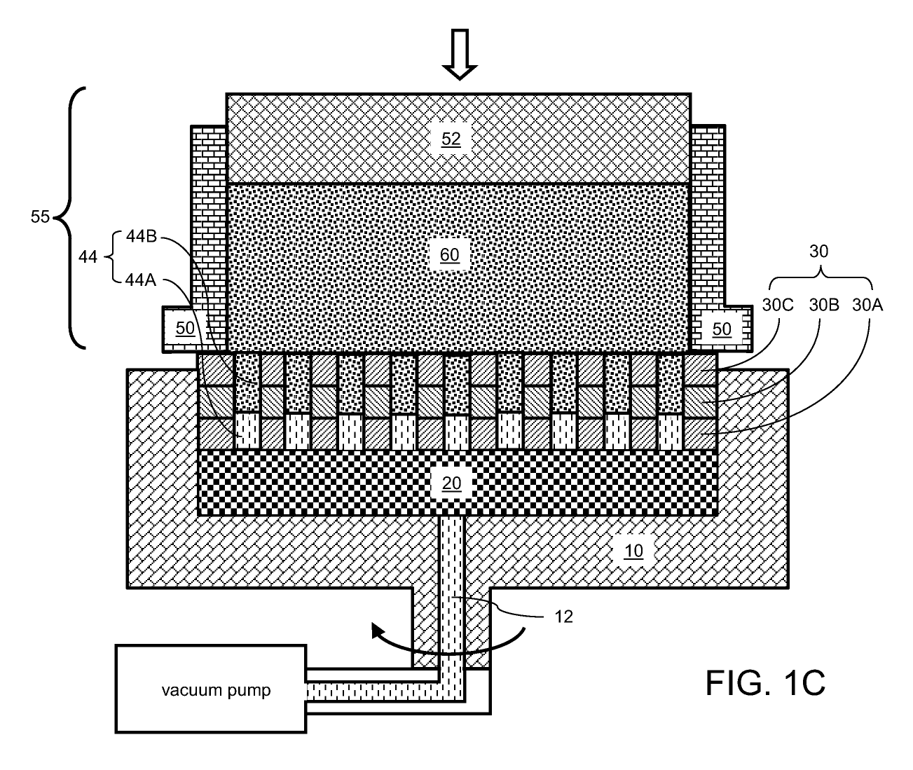

Referring to FIGS. 1A-1C, a first exemplary apparatus according to a first embodiment of the present invention is shown, which can be employed to form at least one seamless conductive solder structure through at least one substrate 30. The first exemplary apparatus includes an upper assembly 55, a lower assembly 15, and a vacuum pump (not shown). The upper assembly 55 and the lower assembly 15 are configured to move relative to each other. The lower assembly 15 is configured to hold the at least one substrate 30, which may include, for example, a stack of a first substrate 30A, a second substrate 30B, and a third substrate 30C. While the present invention is illustrated employing the at least one substrate 30 that includes the first, second, and third substrates (30A, 30B, 30C) that are vertically stacked, the present invention can be employed for a single substrate or a plurality of substrates of any number that are vertically stacked together.

Each of the at least one substrate (30A, 30B, 30C) may be any type of substrate that requires an electrical interconnection or a structural interconnection by at least one through-substrate seamless conductive solder structure 46. For example, the at least one substrate (30A, 30B, 30C) can be a plurality of semiconductor substrates, each including semiconductor chips. The at least one substrate (30A, 30B, 30C) may include a first semiconductor substrate including a plurality of processor core dies, a second semiconductor substrate including a plurality of memory dies, etc.

The various semiconductor substrates in the at least one substrate (30A, 30B, 30C) may be aligned prior to loading onto the chuck 20 so that a plurality of through-substrate holes may be formed while each die in a semiconductor substrate is vertically aligned to all other dies directly above or below in the stack of the at least one substrate (30A, 30B, 30C). The plurality of through-substrate holes are vertically aligned through all substrates in the at least one substrate (30A, 30B, 30C). The horizontal cross-sectional area of each through-substrate hole may be constant across the entirety of each through-substrate hole. The at least one through-substrate seamless conductive solder structure 46 provides electrical connection among the plurality of semiconductor substrates in the at least one substrate (30A, 30B, 30C) such that each vertical stack of semiconductor dies are electrically wired. The horizontal cross-sectional area of each at least one through-substrate seamless conductive solder structure 46 may be constant between the top surface and the bottom surface of the at least one substrate (30A, 30B, 30C).

Upon formation of the at least one through-substrate seamless conductive solder structure 46, stacks of vertically connected dies may be diced out from the at least one substrate (30A, 30B, 30C). Each stack of vertically connected dies includes electrical connections enabled by the at least one through-substrate seamless conductive solder structure 46, which may be employed to provide a power supply grid network, an electrical ground grid network, and/or at least one signal grid network cross multiple dies located at different levels of the vertical stack.

The upper assembly 55 is located above the lower assembly 15 and the at least one substrate 30. The upper assembly 55 is configured to provide a solder material through an opening on a bottom surface of the upper assembly 55. For example, the upper assembly 55 may include an injection mold system having an enclosure 50 with an opening on a bottom surface and a movable extrusion actuator 52 on another opening therein. As the movable extrusion actuator 52 moves, for example, downward in the direction of an arrow in FIGS. 1B and 1C, a solder material 60 within the enclosure 52 extrudes into at least one through-substrate holes in the at least one substrate. Alternatively, the upper assembly 55 may be any other type of device that is configured to extrude a solder material from an opening on a bottom surface.

The lower assembly 15 includes a chuck 10. The chuck 10, which includes a vacuum pumping line 12, is configured to laterally confine the at least one substrate 30. For example, the chuck 10 may have a recessed region having a substantially same horizontal cross-sectional shape as the at least one substrate 30 that is laterally confined by the chuck 10. The vacuum pumping line is connected to the vacuum pump through the vacuum pumping line 12. A filter structure 20 is located within a recessed region of the chuck 10. The filter structure 20 can be a mesh of any solid material, or can be a porous material that retards flow of the solder material therethrough. Preferably, the pumping line is connected directly to a surface of the filter structure 20.

Preferably, the filter structure 20 is made of a heat-resistant material to withstand an elevated temperature of the solder material during extrusion from the upper assembly 55. Typically, the temperature of the solder material from the upper assembly 55 can be from 200° C. to 400° C. during the extrusion depending of the melting point of the solder material, which is a metallic compound including metals such as Sn, Ag, Cu, etc. The filter structure 20 is configured to vertically support a bottom surface of the at least one substrate 30. The filter structure 20 is connected to the vacuum pumping line 12 so that any gas flowing into the filter structure 20 is pumped through the vacuum pumping line 12 into the vacuum pump.

The upper assembly 55 injects the solder material through at least one through-substrate hole extending from a top surface of the at least one substrate 30 to the bottom surface of the at least one substrate 30. At least one through-substrate seamless conductive solder structure 46 that extends from the top surface of the at least one substrate 30 to the bottom surface of the at least one substrate 30 is thereby formed.

The at least one substrate 30 may include a plurality of through-substrate holes. A first group of through-substrate holes may include only an ambient gas. The first group of through-substrate holes is herein referred to as “unfilled through-substrate holes under ambient conditions” 40. A second group of through-substrate holes can be under vacuum when a bottom surface of the upper assembly completely covers an opening on the topmost surface of the at least one substrate 30 while most gas in the second group of through-substrate holes is pumped out through the filter structure 20 and the vacuum pumping line 12 into the vacuum pump. The second group of through-substrate holes is herein referred to as “unfilled though-substrate holes under vacuum” 42. The unfilled through-substrate holes under ambient conditions 40 and the unfilled though-substrate holes under vacuum 42 are collectively referred to as “unfilled through-substrate holes” (40, 42).

A third group of through-substrate holes includes a volume under vacuum 44A and a solder material portion 44B that does not completely fill a through-substrate hole. The third group of through-substrate holes is referred to as “partially-filled through-substrate holes” 44, each of which includes a volume under vacuum 44A and a solder material portion 44B. A fourth group of through-substrate holes are completely filled with a solder material so that a through-substrate solder structure fills each of the fourth group of through-substrate holes. Each through-substrate solder structure is a seamless conductive solder structure including a conducive solder material of a single contiguous piece without an interface or a seam therein.

The filter structure 20 is configured to draw in the ambient gas through unfilled through-substrate holes under ambient conditions 40, each of which is one of the at least one through-substrate hole prior to injection of the solder material and prior to complete covering by the bottom surface of the upper assembly 55. Further, the filter structure 20 is configured to provide a vacuum environment to unfilled though-substrate holes under vacuum 42, each of which is one of a through-substrate hole that a bottom surface of the upper assembly 55 covers prior to injecting the solder material.

Yet further, the filter structure 20 is configured to provide a vacuum environment to an unfilled portion of a partially-filled through-substrate hole 44, i.e., a volume under vacuum, in the at least one substrate 30 while the upper assembly 55 injects the solder material into the partially-filled through-substrate hole 44 to expand a solder material portion 44B, which is a filled portion of the partially-filled through substrate hole 44 that includes the solder material.

The upper assembly 55 can be configured to remain stationary while the lower assembly 15 and the at least one substrate 30 rotate around an axis of the chuck 10. In this case, the chuck 10 and the at least one substrate 30 rotate around the axis of the chuck 10. Preferably, the axis of the chuck 10 is perpendicular to an interface between the upper assembly 55 and the top surface of the at least one substrate 30, which can be parallel to the interface between the filter structure 20 and the at least one substrate 30. The top surface of the at least one substrate 30 can be, but does not need to be, parallel to the bottom surface of the at least one substrate 30.

Alternatively, the lower assembly 15 can be configured to remain stationary and keep the at least one substrate 30 stationary as well, while the upper assembly 55 rotates around an axis of the upper assembly.

The upper assembly 55 is configured to contact the top surface of the at least one substrate 30 without a gap between the upper assembly 55 and the at least one substrate 30. The absence of any gap between the upper assembly 55 and the at least one substrate 30 is maintained during the relative movement between the upper assembly 55 and the at least one substrate 30. Thus, the upper assembly 55 is configured to continuously inject the solder material during a relative movement between the upper assembly 55 and the at least one substrate, while the upper assembly 55 contacts the at least one substrate 30 without a gap.

During the operation of the first exemplary apparatus, the at least one substrate 30, which includes at least one through-substrate hole extending from a top surface of the at least one substrate 30 to the bottom surface of the at least one substrate 30, is placed on the filter structure 20. The chuck 10 laterally confines the at least one substrate 30 and the filter structure 20 vertically supports the bottom surface of the at least one substrate 30. The solder material is injected from the upper assembly 55 into the at least one through-substrate hole. Each of the at least one through-substrate hole changes its state from an unfilled through-substrate holes under ambient conditions 40, to an unfilled though-substrate holes under vacuum 42, then to a partially-filled though-substrate hole 44, and then to a filled through-substrate hole including a through-substrate seamless conductive solder structure 46 until all of the at least one through-substrate hole becomes filled with a through-substrate seamless conductive solder structure 46.

During the extrusion and filling process, the pump provides a vacuum environment to an unfilled portion 44A of a partially-filled though-substrate hole 44 into which the solder material is injected. Each of the at least one through-substrate seamless conductive solder structure 46 extends from the top surface of the at least one substrate 30 to the bottom surface of the at least one substrate 30.

In case the at least one substrate 30 is a plurality of substrates, each of the at least one through-substrate hole extends through each substrate in the plurality of substrates.

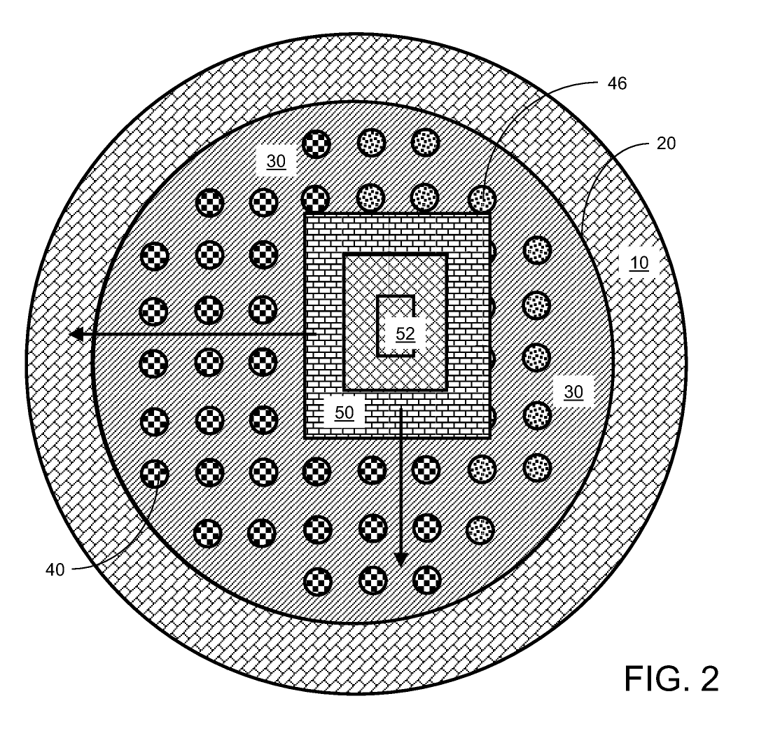

Referring to FIG. 2, a second exemplary apparatus according to a second embodiment of the present invention includes the same elements as the first exemplary apparatus described above with a difference that the upper assembly 55 (See FIGS. 1B and 1C) and/or the lower assembly 15 (See FIGS. 1B and 1C) move relative to each other in a one-dimensional linear motion or in a two-dimensional linear motion. Preferably, the relative motion is designed to provide filling of all through substrate holes in the at least one substrate 30.

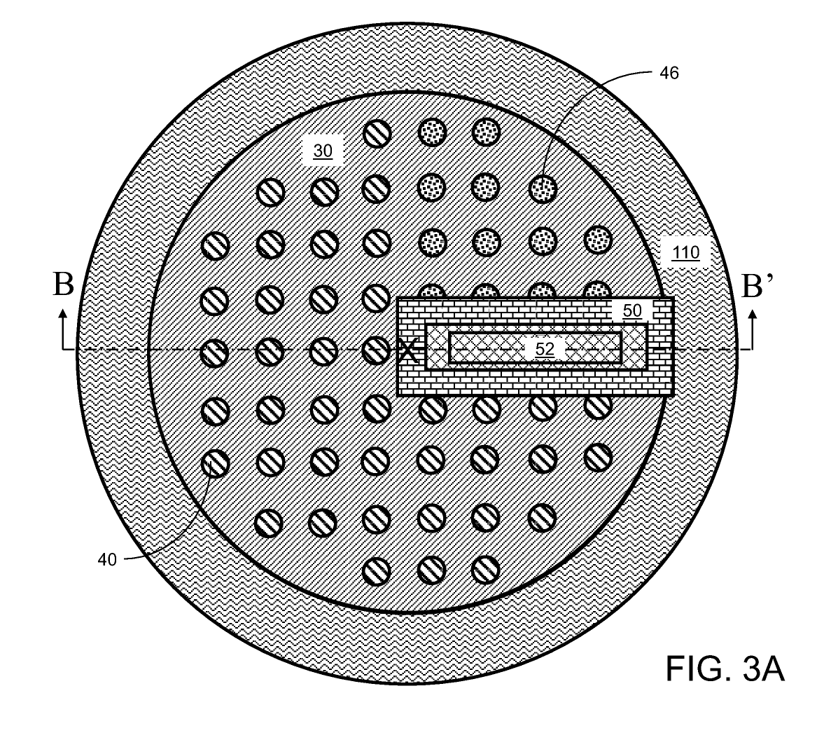

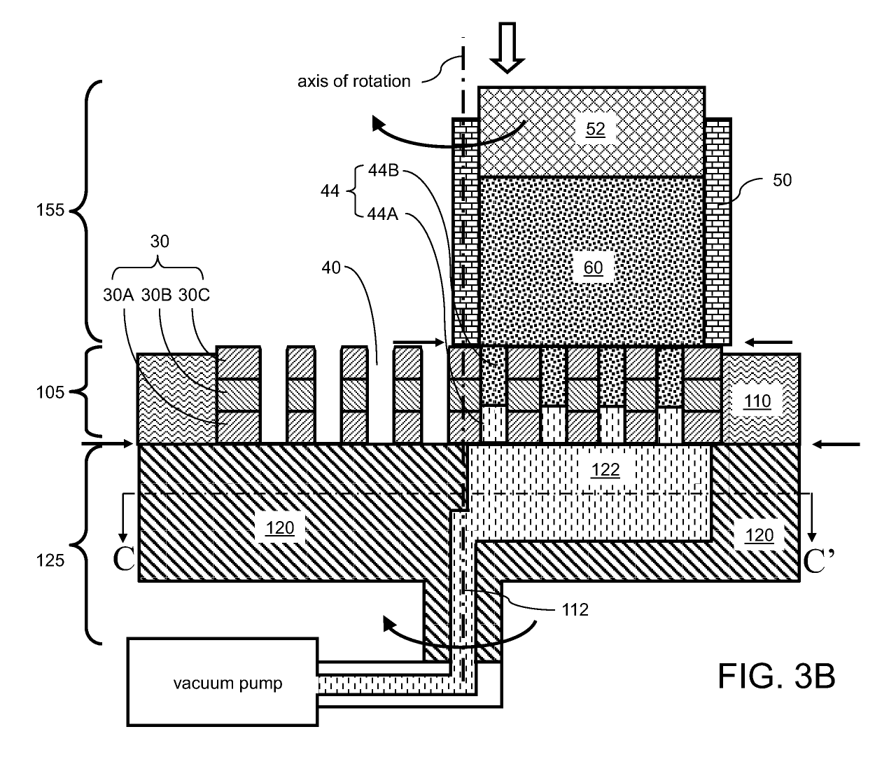

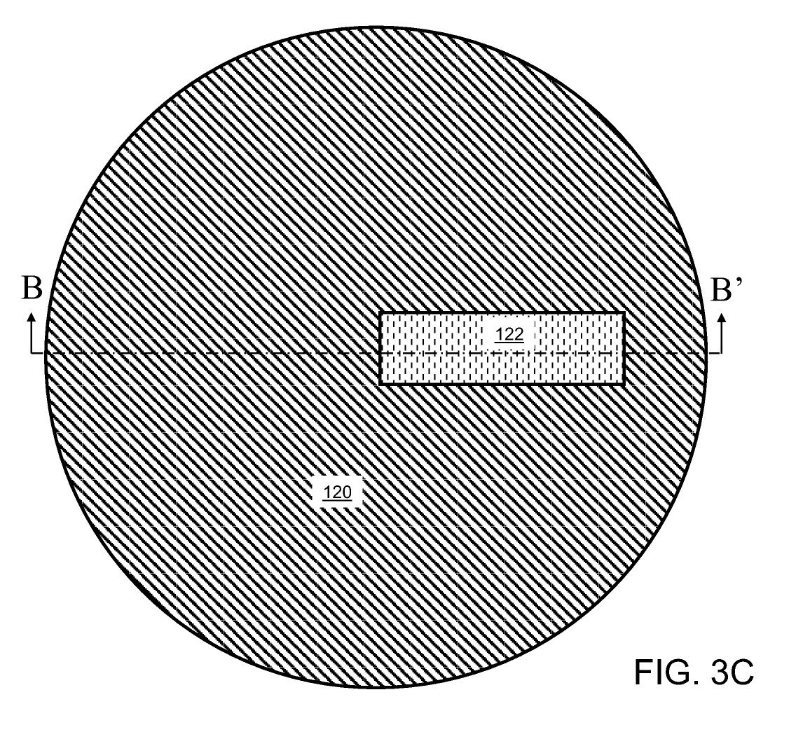

Referring to FIGS. 3A-3C, a third exemplary apparatus according to a third embodiment of the present invention is shown, which can be employed to form at least one seamless conductive solder structure through at least one substrate 30. The third exemplary apparatus includes a set of an upper assembly 155 and a lower assembly 125, a middle assembly 105, and a vacuum pump (not shown). The middle assembly 105 and the set of the upper and lower assemblies (155, 125) are configured to move relative to each other while the upper assembly 155 maintains a same relative position with respect to the lower assembly 125. Thus, in a frame of reference that moves with the upper assembly, the lower assembly 125 looks stationary, while the middle assembly 105 moves relative to the upper assembly 155.

The middle assembly 105 includes a first chuck 110 that is configured to laterally confine at least one substrate 30. Further, the first chuck 110 is configured to maintain a same relative position with respect to the at least one substrate 30. Further, the middle assembly 105 can move relative to the set of the upper and lower assemblies (155, 125) by laterally sliding at two interfaces that are marked by two sets of lateral arrows shown in FIG. 3B.

The upper assembly 155 is located above the middle assembly 105 and the at least one substrate 30. The upper assembly 155 is configured to provide a solder material through an opening on a bottom surface of the upper assembly 155.

The lower assembly 125 includes a second chuck 120. The second chuck includes a vacuum manifold 122 that is connected to the vacuum pump via a vacuum pumping line 112. An opening in the vacuum manifold 122 at the top surface of the second chuck 120 does not extend across the entirety of the top surface of the second chuck 120, but is limited to an area that corresponds to the area of the opening from which the solder material is extruded on the bottom surface of the upper assembly 155. It is critical for the vacuum manifold 122 to evacuate the vias and disengage from the vias before the molten solder is injected to avoid solder getting sucked into the vacuum manifold. In other words, the relative position of the vacuum manifold 122 preceeds the opening slot 52 from which the solder material is extruded. Optionally, a filter structure (not shown) may be placed within the vacuum manifold to retard the flow of the solder material that accidentally extrudes out of the bottom surface of the at least one substrate 30.

The second chuck 120 is configured to vertically support the bottom surface of the at least one substrate 30, and to move relative to the first chuck 110 while the bottom surface of the at least one substrate 30 covers the vacuum manifold 122.

The upper assembly 120 injects the solder material through at least one through-substrate hole extending from a top surface of the at least one substrate 30 to a bottom surface of the at least one substrate 30 to form at least one through-substrate seamless conductive solder structure 46 that extends from the top surface of the at least one substrate 30 to the bottom surface of the at least one substrate 30. The second chuck 120 is configured to provide a vacuum environment to an unfilled portion 44A of a partially-filled through-substrate hole 44 in the at least one substrate 30 while the upper assembly 155 injects the solder material into the partially-filled through-substrate hole 44 to expand a filled portion 44B of the partially-filled through substrate hole 44 that includes the solder material.

The middle assembly 105 can be configured to remain stationary with the at least one substrate 30 while the set of the upper and lower assemblies (155, 125) rotates around an axis of the second chuck 120. In this case, the set of the upper and lower assemblies (155, 125) rotates around the axis of the second chuck 120. The axis of rotation is perpendicular to an interface between the first chuck 110 and the second chuck 120, i.e., perpendicular to the interface between the lower assembly 125 and the at least one substrate 30. Further, the axis of the second chuck 120 is perpendicular to an interface between the upper assembly 155 and the top surface of the at least one substrate 30. The top surface of the at least one substrate 30 is parallel to the bottom surface of the at least one substrate 30 in this case.

Alternatively, the set of the upper and lower assemblies (155, 125) can be configured to remain stationary, while middle assembly 105 and the at least one substrate 30 rotate around an axis of the middle assembly 105.

The upper assembly 155 is configured to contact the top surface of the at least one substrate 30 without a gap between the upper assembly 155 and the at least one substrate 30. The absence of any gap between the upper assembly 155 and the at least one substrate 30 is maintained during the relative movement between the upper assembly 55 and the at least one substrate 30. Thus, the upper assembly 155 is configured to continuously inject the solder material during a relative movement between the upper assembly 155 and the at least one substrate 30, while the upper assembly 155 contacts the at least one substrate 30 without a gap.

During the operation of the third exemplary apparatus, the at least one substrate 30, which includes at least one through-substrate hole extending from a top surface of the at least one substrate 30 to the bottom surface of the at least one substrate 30, is placed on the second chuck 120 and within the first chuck 110. The first chuck 110 laterally confines the at least one substrate 30 and the second chuck 120 vertically supports the bottom surface of the at least one substrate 30. The solder material is injected from the upper assembly 155 into the at least one through-substrate hole. Each of the at least one through-substrate hole changes its state from an unfilled through-substrate hole under ambient conditions 40, to an unfilled though-substrate hole under vacuum, then to a partially-filled though-substrate hole 44, and then to a filled through-substrate hole including a through-substrate seamless conductive solder structure 46 until all of the at least one through-substrate hole becomes filled with a through-substrate seamless conductive solder structure 46.

During the extrusion and filling process, the pump provides a vacuum environment through the vacuum pumping line 112 and the vacuum manifold 122 to an unfilled portion 44A of a partially-filled though-substrate hole 44 into which the solder material is injected. Each of the at least one through-substrate seamless conductive solder structure 46 extends from the top surface of the at least one substrate 30 to the bottom surface of the at least one substrate 30. The vacuum manifold 122 evacuates the unfilled through-substrate hole under ambient conditions 40 and the partially-filled though-substrate hole 44, but is disengaged from the through-substrate seamless conductive solder structure 46 before the molten solder is injected into the vacuum manifold 122. During rotation of the upper assembly 155 relative to the middle assembly 105, the position of the vacuum manifold 122 azimuthally precedes the opening slot 52 from which the solder material is extruded.

In case the at least one substrate 30 is a plurality of substrates, each of the at least one through-substrate hole extends through each substrate in the plurality of substrates.

While the present invention has been particularly shown and described with respect to preferred embodiments thereof, it will be understood by those skilled in the art that the foregoing and other changes in forms and details can be made without departing from the spirit and scope of the present invention. For example, the substrate need not be a circular wafer in rotation, but square or rectangular shaped substrate with the injection molded solder scanning in a linear motion. It is therefore intended that the present invention not be limited to the exact forms and details described and illustrated, but fall within the scope of the appended claims.

What is claimed is:

1. An apparatus for forming at least one seamless conductive solder structure through at least one substrate, said apparatus including a set of an upper assembly and a lower assembly, a middle assembly, and a vacuum pump, wherein said middle assembly and said set of said upper and lower assemblies are configured to move relative to each other while said upper assembly maintains a same relative position with respect to said lower assembly,
wherein said upper assembly is located above said middle assembly, and said upper assembly is configured to provide a solder material through an opening on a bottom surface of said upper assembly,
wherein said middle assembly includes a first chuck configured to laterally confine said at least one substrate and maintain a same relative position with respect to said at least one substrate, wherein said lower assembly includes a second chuck including a vacuum manifold that is connected to said vacuum pump,
whereby said upper assembly injects said solder material through at least one through-substrate hole extending from a top surface of said at least one substrate to a bottom surface of said at least one substrate to form at least one through-substrate seamless conductive solder structure that extends from said top surface of said at least one substrate to said bottom surface of said at least one substrate.

2. The apparatus of claim 1, wherein said second chuck is configured to vertically support said bottom surface of said at least one substrate and to move relative to said first chuck while said bottom surface of said at least one substrate covers said vacuum manifold.

3. The apparatus of claim 2, wherein said second chuck is configured to provide a vacuum environment to an unfilled portion of a partially-filled through-substrate hole in said at least one substrate while said upper assembly injects said solder material into said partially-filled through-substrate hole to expand a filled portion of said partially-filled through substrate hole that comprises said solder material.

4. The apparatus of claim 1, wherein said middle assembly is configured to remain stationary with said at least one substrate while said set of said upper and lower assemblies rotates around an axis of said second chuck.

5. The apparatus of claim 2, wherein said axis is perpendicular to an interface between said first chuck and said second chuck.

6. The apparatus of claim 1, wherein said upper assembly is configured to contact said top surface of said at least one substrate without a gap.

7. The apparatus of claim 6, wherein said upper assembly is configured to continuously inject said solder material during a relative movement between said set of said upper and lower assemblies and said middle assembly, while said upper assembly contacts said at least one substrate without a gap.

8. A method of forming at least one seamless conductive solder structure through at least one substrate, said method including:
providing an apparatus including an upper assembly, a lower assembly, and a vacuum pump, wherein said upper assembly and said lower assembly are configured to move relative to each other, said lower assembly includes a chuck and a filter structure, and said chuck includes a vacuum pumping line that is connected to said vacuum pump, and said filter structure is located within a recessed region of said chuck;
placing on said filter structure at least one substrate including at least one through-substrate hole extending from a top surface of said at least one substrate to said bottom surface of said at least one substrate, wherein said chuck laterally confines said at least one substrate and said filter structure vertically supports said bottom surface of said at least one substrate; and
injecting a solder material from said upper assembly into said at least one through-substrate hole, wherein said pump provides vacuum environment to an unfilled portion of a though-substrate hole into which said solder material is injected, whereby at least one through-substrate seamless conductive solder structure that extends from said top surface of said at least one substrate to said bottom surface of said at least one substrate is formed.

9. The method of claim 8, wherein said at least one substrate is a plurality of substrates, and wherein each of said at least one through-substrate hole extends through each substrate in said plurality of substrates.

10. The method of claim 8, wherein said filter structure draws in an ambient gas through said at least one through-substrate hole prior to injection of said solder material, and said filter structure provides a vacuum environment in a through-substrate hole while a bottom surface of said upper assembly covers said through-substrate hole prior to injecting said solder material.

11. The method of claim 10, wherein said filter structure provides a vacuum environment to an unfilled portion of a partially-filled through-substrate hole in said at least one substrate while said upper assembly injects said solder material into said partially-filled through-substrate hole to expand a filled portion of said partially-filled through substrate hole that comprises said solder material.

12. The method of claim 8, further comprising maintaining said upper assembly stationary while rotating said chuck and said at least one substrate around an axis of said chuck.

13. The method of claim 8, further comprising continuously injecting said solder material from said upper assembly, while providing a relative movement between said upper assembly and said lower assembly, and while maintaining a contact between said upper assembly and said lower assembly without a gap.

14. A method of forming at least one seamless conductive solder structure through at least one substrate, said method including:
providing an apparatus including a set of an upper assembly and a lower assembly, a middle assembly, and a vacuum pump, wherein said middle assembly and said set of said upper and lower assemblies are configured to move relative to each other while said upper assembly maintains a same relative position with respect to said lower assembly, said middle assembly includes a first chuck configured to laterally confine said at least one substrate and maintain a same relative position with respect to said at least one substrate, and said lower assembly includes a second chuck including a vacuum pumping line that is connected to said vacuum pump;
placing on said second chuck at least one substrate including at least one through-substrate hole extending from a top surface of said at least one substrate to said bottom surface of said at least one substrate, wherein said first chuck laterally confines said at least one substrate and said second chuck vertically supports said bottom surface of said at least one substrate; and
injecting a solder material from said upper assembly into said at least one through-substrate hole, wherein said pump provides vacuum environment to an unfilled portion of a though-substrate hole into which said solder material is injected, whereby at least one through-substrate seamless conductive solder structure that extends from said top surface of said at least one substrate to said bottom surface of said at least one substrate is formed.

15. The method of claim 14, wherein said at least one substrate is a plurality of substrates, and wherein each of said at least one through-substrate hole extends through each substrate in said plurality of substrates.

16. The method of claim 14, wherein said second chuck vertically supports said bottom surface of said at least one substrate and moves relative to said first chuck while said bottom surface of said at least one substrate covers said vacuum manifold.

17. The method of claim 15, wherein said vacuum pump provides a vacuum environment through said vacuum manifold to an unfilled portion of a partially-filled through-substrate hole in said at least one substrate while said upper assembly injects said solder material into said partially-filled through-substrate hole to expand a filled portion of said partially-filled through substrate hole that comprises said solder material.

18. The method of claim 14, further comprising maintaining said middle assembly and said at least one substrate stationary while rotating said set of said upper and lower assemblies around an axis of said second chuck.
